(19) United States
(12) Patent Application Publication
(10) Pub. No.: US 2007/0032562 A1
(43) Pub. Date: Feb. 8, 2007

(54) Redox polymerization of vinyl aromatic monomers by photosynthesis

(76) Inventors: Jose Sosa, Deer Park, TX (US); Jay Reimers, Houston, TX (US)

Correspondence Address: FINA TECHNOLOGY INC, PO BOX 674412, HOUSTON, TX, 77267-4412, US

(21) Appl. No.: 11/198,542

(22) Filed: Aug. 4, 2005

(51) Int. Cl. C08F 2/50

(52) U.S. Cl. 522/6

(57) ABSTRACT

A method for the production of a vinyl aromatic polymer through the use of a supported light-induced photoreductant. A reactor is provided which contains a catalyst bed comprising a light-induced photoreductant component supported on a particulate substrate forming a permeable catalyst bed. A reaction stream comprising a vinyl aromatic monomer, a soluble reductant, and a transition metal salt is introduced into the reactor and passed through the catalyst bed. In addition, a gaseous oxidizing agent is introduced into the reactor and flowed through the catalyst bed and into contact with the reaction stream. The catalyst bed is irradiated with electromagnetic radiation in the ultraviolet or visible light range at an intensity sufficient to activate the photoreductant component and produce a free radical to initiate polymerization of the vinyl aromatic monomer to form a corresponding vinyl aromatic polymer. The vinyl aromatic polymer is then recovered from the reactor. The photoreductant component is a photoreductant dye, such as a group consisting of acridine, methylene blue, rose bengal, tetraphenylporphine, A protoporphyrin, A phthalocyanine and eosin-y and erythrosin-b. The transition metal salt may be an iron, cobalt or manganese salt and the soluble reductant is selected from the group consisting of diethanolamine, thiodiethanol, triethanolamine, benzoin, ascorbic acid, ester, glyoxal trimer and toluene sulfinic acid.

### BACKGROUND OF THE INVENTION

Vinyl aromatic polymers, such as styrene-based homopolymers or styrene/diene-based copolymers such as high impact polystyrene (HIPS), may be produced through chain or addition polymerization reactions which involve the use of free radical initiators. The free radical initiator reacts with a styrene or other vinyl aromatic monomer to start the growing polymer chain which continues to add monomer units as long as free radicals and monomer units are available. An example of the free radical polymerization of styrene to produce polystyrene and more particularly, styrene-butadiene graft copolymers is found in U.S. Pat. No. 6,770,716 to Sosa et al. As disclosed in Sosa et al., commercially available peroxide or hydroperoxide-based initiators are employed in conjunction with an accelerator such as a metal salt or a metal salt-hydroperoxide combination in order to accelerate the chain addition polymerization process.

Free radical based polymerization can also be employed to produce rubber-containing polymerization solutions. Thus, as disclosed in U.S. Pat. No. 5,075,346 to Platt et al., light-induced photoreductant formulations can be employed to produce hydroperoxide derivatives of rubber by the reduction of triplet state oxygen to singlet state oxygen. As disclosed in the Platt et al. patent, various photosensitizing agents such as methylene blue, rose bengal, and others are dissolved in a solution of a rubbery polymer through the use of an alcohol-based solubilizer such as methanol, which enhances the solubility of the photosensitizing agent in the rubber solution. The rubbery solution containing the photosynthesizing agent is oxygenated and then subjected to irradiation with light having a wavelength in the 300-800 angstrom region to convert triplet oxygen to singlet oxygen for use in the polymerization of the rubber-containing solution.

### SUMMARY OF THE INVENTION

In accordance with the present invention, there is provided a method for the production of a vinyl aromatic polymer such as polystyrene homopolymer or a styrene-diene copolymer through the use of a supported light-induced photoreductant. In carrying out the present invention, there is provided a reactor containing a catalyst bed comprising a light-induced photoreductant component supported on a particulate substrate forming a permeable catalyst bed. A reaction stream comprising a vinyl aromatic monomer, a soluble reductant, and a transition metal salt is introduced into the reactor and passed through the catalyst bed. Concomitantly with the introduction of the reaction stream into the reactor, a gaseous oxidizing agent is introduced into the reactor and flowed through the catalyst bed and into contact with the reaction stream. The catalyst bed containing the reaction stream and the gaseous oxidizing agent is irradiated with electromagnetic radiation in the ultraviolet or visible light range at an intensity sufficient to activate the photoreductant component and produce a free radical to initiate polymerization of the vinyl aromatic monomer to form a corresponding vinyl aromatic polymer. The vinyl aromatic polymer is then recovered from the reactor. In a specific embodiment of the invention, the photoreductant component is a photoreductant dye, more specifically a dye selected from a group consisting of acridine, methylene blue, rose bengal, tetraphenylporphine, A protoporphyrin, A phthalocyanine and eosin-y and erythrosin-b. The transition metal salt is preferably a salt of iron, cobalt or manganese and the soluble reductant is selected from the group consisting of diethanolamine, thiodiethanol, triethanolamine, benzoin, ascorbic acid, ester, glyoxal trimer and toluene sulfinic acid.

In one embodiment of the invention, the vinyl aromatic monomer is styrene and the polymerization reaction is carried out to produce polystyrene. In another embodiment of the invention, the vinyl aromatic polymer is styrene with the reaction stream also containing a copolymerizable monomer or polymer to produce a styrene copolymer. The styrene may be copolymerized with butadiene to produce a styrene-butadiene copolymer. In a specific embodiment of the invention, the reactive dye is methylene blue and the soluble reductant is benzoin, employed in an amount within the range of 10-500 ppm based upon the amount of the vinyl aromatic monomer.

Preferably, the gaseous oxidizing agent and the reaction stream are passed through the reaction under concurrent flow conditions. In one embodiment of the invention, the reactor comprises a tubular outer shell and a tubular inner member having a permeable wall which defines an annular space between the inner member and the outer shell. The photoreductant-containing particulate substrate is disposed within this annular space. The gaseous oxidizing agent is introduced into the interior tubular member and radially dispersed outwardly from the tubular member into contact with the supported reductant component disposed in the annular space. Preferably, the electromagnetic radiation has a wavelength predominantly within the region of 300-700 nm and the reaction stream is irradiated in contact with the photoreductant component at an illumination intensity within the range of 10-300 footcandles. In a further embodiment of the invention, the particulate substrate comprises an inorganic particulate material having a predominant particle size within the range of 0.2-0.8 cm. Preferably the support is selected from the group consisting of silica, alumina and mixtures thereof. The support may have an average particle size within the range of 0.3-0.7 cm. In a further embodiment of the invention, the photoreductant component is supported on the particulate substrate in an amount within the range of 0.01-0.1 grams of photoreductant component per gram of support.

In one embodiment of the invention, the catalyst bed is illuminated with electromagnetic radiation from a radiation source located externally of the reactor, with the catalyst bed subject to illumination by the exterior radiation source having a thickness of no more than 10 cm. In another embodiment of the invention, the catalyst bed is illuminated with electromagnetic radiation from a radiation source disposed internally within the reactor. In this embodiment of the invention, the reactor may comprise an outer shell and an internal well structure in which a source of illumination is located. The well structure and the outer shell-define an annulus surrounding the source of illumination in which the catalyst bed is located.

The reactant system through which the dispersion is passed can take the form of two or more reactors connected in series with one another or can be two or more reactors connected in parallel with one another. Preferably, the reactors are spaced laterally from one another to provide for an array of reactors with parallel flow of the dispersion and the gaseous oxidizing agent and the catalyst beds are irradiated with a source of electromagnetic radiation located externally of the reactor array. In another embodiment of the invention, the reactor takes the form of an outer shell and an internal well structure within the outer shell to define an annulus. An illumination source is located within the internal well structure to provide for illumination of the supported photoreductant and reaction stream within the annular space surrounding the source of illumination.

### BRIEF DESCRIPTION OF THE DRAWINGS

FIG. 1 is a side elevation schematic illustration of a reactor system for carrying out the present invention.

FIG. 2 is a side elevation schematic illustration of another form of reactor system suitable for carrying out the present invention.

FIG. 3 is a schematic illustration of a plurality of series connected reactors useful in carrying out the invention.

FIG. 4 is a side elevation schematic illustration of a plurality of parallel connected reactors useful in carrying out the invention.

FIG. 5 is a plan view of a plurality of parallel connected reactors arranged in an array surrounding an internal light source.

### DETAILED DESCRIPTION OF THE INVENTION

As noted previously, vinyl aromatic monomers such as styrene, alpha styrene and ring-substituted alkyl styrenes, such as ortho-, meta-, or para-methyl styrene are polymerized through the use of free radical initiators. While numerous free radical initiators are available to support the production of styrene-based homopolymers or copolymers, hydroperoxide-type initiators are particularly effective in the free-radical polymerization of styrenes and other vinyl aromatic monomers. The present invention employs an accelerator of the type disclosed in the aforementioned patent to Sosa et al. in the polymerization of vinyl monomers to produce vinyl aromatic polymers and copolymers. In this invention, however, in addition to the accelerator systems disclosed in Sosa et al., the present invention involves the use of a photosensitive reductant such as the photosensitive dyes disclosed in the aforementioned patent to Platt et al. in order to produce free radicals to initiate and support the polymerization of the vinyl aromatic monomers. However, in contrast to the procedure in the Platt et al. patent in which the photoreductant dye is dissolved in a reaction stream, in the case of Platt et al. a rubbery polymer such as polybutadiene rubber dissolved in a hydrocarbon solvent such as styrene, the present invention proceeds in a contrary manner to employ a photoreductant component such as a photoreductant dye of the type as disclosed in Platt et al. which is supported on a particulate substrate. Thus, the photoreductant component is fixed with respect to the reaction stream containing the polymerizable monomer or monomers. Accordingly, the photoreductant component is not consumed in the course of the polymerization process and is not present in the ultimate polymer product. This fixed configuration of the photoreductant component permits much higher levels of the photocatalyst system to be employed than would be the case in which a solubilized dye is employed which ultimately might have an effect on the physical appearance of the polystyrene or other vinyl aromatic polymer product. By virtue of the higher concentration of photoreductant, the photooxidation in the system is substantially increased, with an attendant increase in the yields of hydroperoxide which is effective to support rapid polymerization of the vinyl aromatic feed stream and at lower temperatures than would otherwise be the case.

While the present invention is particularly effective in the homopolymerization of styrene to produce polystyrene homopolymer or in the copolymerization of styrene and polybutadiene to produce high impact polystyrene, various other reaction streams of vinyl aromatic monomer may be employed. For example, the styrene monomer, or substituted styrene monomer as described above, can be copolymerized with other monomers such as methacrylate, methyl acrylate, butyl acrylate, ethyl methacrylate, vinyl chloride and various other unsaturated monomers which can be copolymerized with styrene.

In addition to the supported reductant component, the present invention also makes use of an accelerator of the type disclosed in the aforementioned U.S. Pat. No. 6,770,716 to Sosa et al. and a soluble reductant which is incorporated into the vinyl aromatic-containing reaction stream. Suitable accelerators are in the form of transition metal salts, particularly salts of Group 7-11 transition metals and more particularly, salts of iron, cobalt or manganese which are soluble in the reaction stream. By way of example, a suitable accelerator salt may take the form of ferric ethyl hexonate, dissolved in a 50% solution of mineral oil, for incorporation into the reaction stream. The accelerator metal salt may be complimented by a hydroperoxide component as disclosed in the patent to Sosa et al. and for a further description of metal salt based accelerator systems which may be employed in the present invention, reference is made to the aforementioned U.S. Pat. No. 6,770,716 to Sosa et al., the entire disclosure of which is incorporated herein by reference.

Soluble reductants which may be employed in carrying out the present invention involve reductants such as diethanolamine, thiodiethanol; triethanolamine; benzoin; ascorbic acid, ester; glyoxal trimer and toluene sulfinic acid. Various soluble reductants which can be employed in the photo-initiated polymerization are disclosed in Odian, George G., “Principles of Polymerization,” Third Edition, John Wiley & Sons, Inc. (1991), in Chapter 3, “Radical Chain Polymerization” and particularly in Section 3-4, “Initiation,” found on pages 211-240. Suitable photoreductant dyes which can be employed to provide the supported photoreductant component include acridine, methylene blue, thionine, fluoroscein, rose bengal, tetraphenylporphine, A protoporphyrin, A phthalocyanine and eosin-y and erythrosin-b. For a further description of photosynthesized polymerizations and the various photoreductants which may employed in carrying out the present invention, reference is made to the aforementioned text of Odian, pages 210-240 and the aforementioned U.S. Pat. No. 5,075,347 to Platt et al., the entire disclosures of which are incorporated herein by reference.

As noted previously, although various components of the type disclosed in Platt et al. or Odian may be used in carrying out the present invention, the invention employs a different mode of operation which involves supporting the photoreductant dye component on a particulate support. The supports employed in carrying out the present invention may be of any suitable type which function when the photoreductant component is supported thereon to form a permeable catalyst bed. Support materials for use in the present invention include inorganic support particles, such as silica and alumina particles. Other substrate materials which can be employed to provide support for the photoreductant component include plastic materials such as polystyrenes, which are disclosed in U.S. Pat. No. 4,849,076 to Neckers et al. Preferably, however, inorganic substrates such as silica and alumina particles are employed in carrying out the invention, since the photoreductant formulations can be effectively bonded to such inorganic substrate particles. The supported photoreductant particles are disposed in a suitable catalyst bed of various configurations as described below in order to provide a permeable bed through which the reaction stream comprises a vinyl aromatic monomer, and optionally a suitable comonomer component, can be passed under a moderate pressure gradient, along with the air other gaseous oxidizing agents using in carrying out the invention.

In experimental work respecting the invention, methylene blue was found to be effectively supported on two different alumina supports and on a silica support. The alumina supports were available from Alcoa—under the designation F-200 in two different particles sizes. One particle size was composed predominantly of ⅛ inch alumina spheres and the other alumina support was composed predominantly of ¼ inch alumina spheres. The silica was a silica gel obtained from EM Science (Gibbstown, N.J.) in an irregular shaped 3 to 8-mesh particle size, that is, the silica particles passed through an 3-mesh screen and were retained on an 8-mesh screen, and was available under the designation SX0143R-1. The two different sizes of the F-200 alumina were used, i.e., ¼″ and ⅛″ spheres. The alumina was pretreated by adjusting the pH of an aqueous suspension to 11, and then drying the alumina at 200° C. for at least a day. No pretreatment was employed for the silica gel. Each support was then added to dry toluene, and after dissipation of the resulting exotherm, a solution of methylene blue in methylene chloride was added, and the dispersions were rolled on a roller for 12 hours. Catalyst break-up was observed when the methylene chloride was added to the silica gel, but the alumina remained intact. The resulting alumina supports contained about 0.10 moles of methylene blue per gram of support, and the silica gel contained about 0.20 moles of methylene blue per gram of support.

Polymerization experiments were carried out using a reaction mixture of 96% styrene and 4 wt. % of a polybutadiene rubber available from Firestone under the designation Diene 35. The polymerization experiments were carried out with a catalyst bed formed of methylene blue supported on the previously described ¼ in. alumina spheres available from Alcoa under the designation F-200. The methylene blue was supported on the alumina spheres in a concentration of 0.04 g of methylene blue to 100 g of alumina. 450 g of the above-identified reaction mixture was employed with 100 g of the methylene blue-alumina support and was exposed to 60 footcandles of light for exposure times of 10 and 20 minutes. The polymerization runs were carried out at a temperature profile of 2 hours at 110° C., 1 hour at 130° C. and 1 hour at 150° C. under a nitrogen atmosphere. The polymerization rate was measured at 150° C.

The runs were conducted with a reaction mixture which was free of a soluble reductant and transition metal and using benzoin, triethanolamine, and diethanolamine as soluble reductants. In two runs, the soluble reductants were used with an iron salt in the amount of 5 ppm based upon the reaction mixture.

The results of this set of experiments are set forth in Table I. In Table I, the last column presents the percent of polymer produced per hour for the experimental runs identified as runs 1-8. As can be seen from an examination of the data presented in Table I, for the benzoin system, employed in each case without the presence of the transition metal salt, polymerization appeared to peak at a benzoin concentration of about 250 ppm. The polymerization rate doubled from the benzoin-free system, but thereafter appeared to fall off as the benzoin concentration was increased. Somewhat similar results were shown for the triethanolamine system, although the decline observed for 500 ppm triethanolamine was less than for the benzoin system and the polymerization rate remained well above the polymerization rate observed for the additive-free system. The use of iron in an amount of 5 ppm resulted in a modest increase in the polymerization rate at the 250 ppm triethanolamine level. For the diethanolamine system depicted in runs 7 and 8, a high polymerization rate was observed with the use of iron providing a modest increase in polymerization rate for the system containing 500 ppm diethanolamine.

TABLE I

| | Exposure | Additive | Metal | % Polymer/ |
|---|---|---|---|---|
| Experiment | Minutes | (PPM) | (PPM) | hr |
| 1 | none | none | None | 14.6 |
| 2 | 10 | Benzoin (250) | None | 29 |
| 3 | 10 | Benzoin (500) | None | 11 |
| 4 | 20 | Triethanolamine (250) | None | 26.3 |
| 5 | 20 | Triethanol amine (250) | Fe (5) | 27.7 |
| 6 | 20 | Triethanolamine (500) | None | 22.6 |
| 7 | 10 | Diethanolamine (500) | None | 29 |
| 8 | 20 | Diethanolamine (500) | Fe(5) | 29.8 |

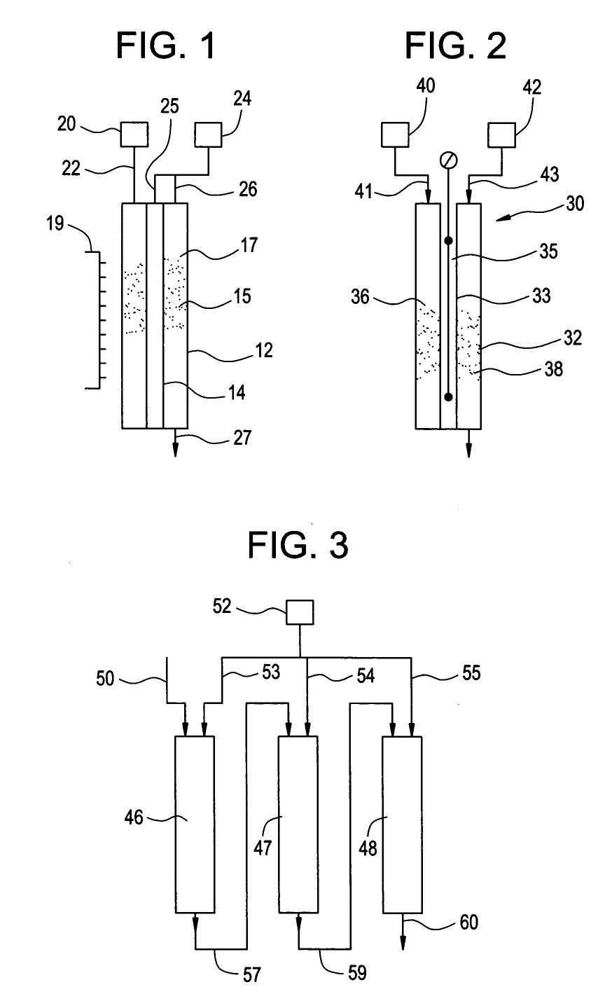

Turning now to the drawings and referring first to FIG. 1, there is illustrated a schematic diagram of one form of a reactor system suitable for carrying out the invention. As shown in FIG. 1, the reactor 10 that comprises a tubular outer shell 12 and a tubular inner members 14. Members 12 and 14 define an annulus 15 which contains a catalyst bed 17 formed by particles of a substrate material as described above upon which is supported a photoreductant component. All or part of the wall portion of the tubular member 12 is transparent to electromagnetic radiation in the ultraviolet or visible light range. A source of radiation 19 is disposed along outer tubular member and opposed to a transparent wall section thereof. A reaction mixture of a vinyl aromatic monomer, a soluble reductant and a transition metal salt in a container 20 is supplied via input line 22 to the top of the reactor and into the permeable annular catalyst bed. A gaseous oxidizing agent such as air or oxygenated air is supplied from a source 24 through a line 25 to the interior of tubular inner member 14 and preferably also through a line 26 to the interior of the annular space 15. The oxygen flows into tubular member 14 and through the permeable wall thereof into the surrounding catalyst bed. In addition, oxygen is also supplied via line 26 directly to the annular space. The light source 19 radiates the catalyst bed containing the reaction stream and the oxygen at an intensity sufficient to activate the supported photoreductant and produce free radicals in a quantity sufficient to initiate and sustain the polymerization reaction. After a suitable residence time within the reactor, the resulting polymer is recovered through an outlet line 27.

Referring now to FIG. 2, there is illustrated a reactor 30 to be employed in another embodiment of the invention in which a source of illumination is located internally within a permeable catalyst bed containing a supported photoreductant component. As shown in FIG. 2, the reactor 30 comprises an outer shell member 32 and an internal well structure 33 within which a source of illumination 35 is located. The well structure 33 is formed of glass or transparent plastic and defines an annulus 36 within which particles comprising a light induced photoreductant component supported on a particulate substrate are arranged to provide a permeable catalyst bed 38. A reaction mixture as described previously is supplied from a container 40 through line 41 into the annulus and flows through the catalyst bed 38. A gaseous oxidizing agent is simultaneously supplied into the annulus 36 for flow through catalyst bad from an oxygen source 42 and an inlet line 43.

In a preferred embodiment of the invention a plurality of reactors such as those depicted in FIG. 1 or FIG. 2 may be employed in carrying out the invention. The reactors may be arranged in a series or in parallel. FIG. 3 illustrates a reactor system comprising a plurality of series connected reactors 46, 47 and 48. Each of reactors 46, 47 and 48 contain a permeable catalyst bed as described previously and are supplied with a reaction mixture supplied to the first reactor 46 via line 50 and a gaseous oxidizing agent supplied from a suitable source 52 to reactors 46, 47 and 48 via lines 53, 54 and 55 respectively. Reactors 46, 47 and 48 may be configured after the previously described reactors 12 and 32 or they may be in any other suitable form. In any case, each reactor contains a permeable catalyst bed as described previously (not shown) and the system is configured with a suitable illumination system (not shown) to radiate the reaction stream as it flows sequentially through the catalyst beds. As indicated in FIG. 3, the output from reactor 46 is supplied via line 57 to the top of catalyst bed in reactor 47 and the outlet from reactor 47 is supplied via line 59 to the top of reactor 48. The output from reactor 48 is supplied through an outlet line 60 to a suitable gathering system, or if additional series connected reactors are deployed, to the top of the next reactor in the cascade arrangement.

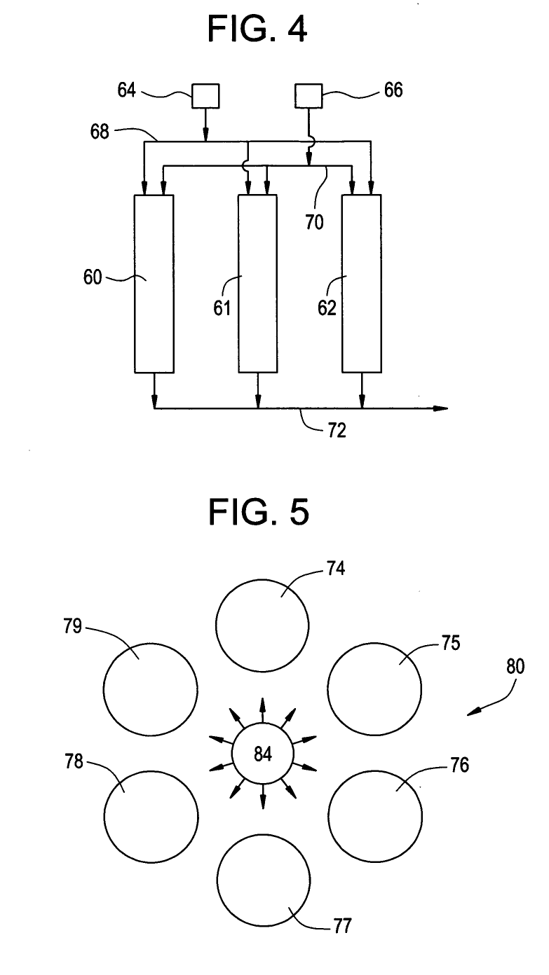

In yet another embodiment of the invention, a reactor system comprising a plurality of reactors connected in parallel with one another are employed in carrying out the present reaction. In this embodiment of the invention, as illustrated in FIG. 4, a plurality of reactors 60, 61 and 62 are arranged in parallel and connected to a source 64 of a reaction mixture and a source of a gaseous oxidizing agent 66 through input manifolds 68 and 70 respectively. Each of the reactors contains a permeable catalyst bed (not shown) and the system is provided with a suitable illumination system (not shown) for irradiating the catalyst beds with ultraviolet or visible light. The outputs from reactors 60, 61 and 62 are supplied to a production manifold system 72.

FIG. 5 is a schematic plane view of a plurality of reactors arranged in a parallel flow configuration. More specifically and as shown in FIG. 5, reactors 74 through 79 are arranged spaced laterally from one another to provide a reactor array 80. The reactor array is provided a suitable inlet and outlet manifolding (not shown) for the flow of oxygen and the reaction stream into the catalyst beds within the reactors and an outlet manifold for the collection of the resulting polymer. An elongated light source 84 is located internally within the array so as to radiate the reaction stream flowing through the reactors each of which, of course, have a transparent external walls opposed to the light source. In addition, one or more sources of light or ultraviolet radiation may be located externally of the reactor array to provide additional illumination.

Having described specific embodiments of the present invention, it will be understood that modifications thereof may be suggested to those skilled in the art, and it is intended to cover all such modifications as fall within the scope of the appended claims.

1. A method for the production of a vinyl aromatic polymer comprising:
(a) providing a reactor containing a catalyst bed comprising a light-induced photoreductant component supported on a particulate substrate forming a permeable catalyst bed;
(b) introducing into said reactor a reaction stream comprising a vinyl aromatic monomer, a soluble reductant and a transition metal salt and passing said reaction stream through said catalyst bed;
(c) concomitantly with subparagraph (b), passing a gaseous oxidizing agent into said reactor and flowing said gaseous oxidizing agent through said catalyst bed and into contact with said reaction stream;
(d) irradiating said catalyst bed containing said reaction stream with electromagnetic radiation in the ultraviolet or visible light range at an intensity sufficient to activate said photoreductant and produce a free radical to initiate polymerization of said vinyl aromatic monomer to form a vinyl aromatic polymer; and
(e) recovering said vinyl aromatic polymer from said reactor.

2. The method of claim 1 wherein said photoreductant component is a photoreductant dye.

3. The method of claim 2 wherein said photoreductant dye is selected from the group consisting of acridine, methylene blue, rose bengal, tetraphenylporphine, A protoporphyrin, A phthalocyanine and eosin-y and erythrosin-b.

4. The method of claim 2 wherein said transition metal salt is a salt of iron, cobalt or manganese.

5. The method of claim 4 wherein said soluble reductant is selected from the group consisting of diethanolamine, thiodiethanol, triethanolamine, benzoin, ascorbic acid, ester, glyoxal trimer and toluene sulfinic acid.

6. The method of claim 5 wherein said vinyl aromatic monomer is styrene and said vinyl aromatic polymer is polystyrene.

7. The method of claim 5 wherein said vinyl aromatic polymer is styrene and said reaction stream contains a copolymerizable monomer or polymer wherein said vinyl aromatic polymer is a styrene copolymer.

8. The method of claim 5 wherein said reactive dye is methylene blue and said soluble reductant is benzoin in an amount within the range of 10-500 ppm, based upon said vinyl aromatic monomer.

9. The method of claim 1 wherein said gaseous oxidizing agent and said reaction stream are passed through said reactor in concurrent flow.

10. The method of claim 1 wherein said reactor comprises a tubular outer shell and a tubular inner member having a permeable wall defining an annular space between said inner and said outer shell and wherein said photoreductant-containing particulate substrate is disposed within said annular space.

11. The method of claim 10 wherein said oxidizing agent is introduced into the inlet end of said reactor into said interior tubular member and radially dispersed outwardly from said tubular member to said supported photoreductant disposed in said annular space.

12. The method of claim 1 wherein said electromagnetic radiation has a wavelength predominantly within the 300-700 nanometers region.

13. The method of claim 1 wherein said reaction stream is irradiated in contact with said photoreductant component at an illumination intensity within the range of 10-300 footcandles.

14. The method of claim 1 wherein said particulate substrate comprises an inorganic particulate material having the predominant particle size within the range of 0.2-0.8 cm.

15. The method of claim 14 wherein said inorganic support is selected from the group consisting of silica, alumina and mixtures thereof.

16. The method of claim 1 wherein said photoreductant component is supported on said particulate substrate in an amount within the range of 0.01-0.1 grams of photoreductant component per gram of support.

17. The process of claim 1 wherein said catalyst bed is illuminated with said electromagnetic radiation from a radiation source located externally of said reactor.

18. The process of claim 17 wherein said catalyst bed has a thickness subject to illumination by said exterior radiation source of no more than 10 cm.

19. The process of claim 1 wherein said catalyst bed is illuminated with said electromagnetic radiation from a source of said radiation disposed internally within said reactor.

20. The method of claim 19 wherein said reactor comprises an outer shell and an internal well structure within which said source of illumination is located, wherein said well structure and said shell define an annulus surrounding said source of illumination in which said catalyst bed is located.

21. A method for the production of a vinyl aromatic polymer comprising:
(a) providing a plurality of reactors each containing a catalyst bed comprising a light-induced photoreductant component supported on a particulate substrate forming a permeable catalyst bed;
(b) introducing into said reactors a reaction stream comprising a vinyl aromatic monomer, a soluble reductant and a transition metal salt and passing said reaction stream through the catalyst beds of said reactors;
(c) concomitantly with subparagraph (b), passing a gaseous oxidizing agent into said reactors and flowing said gaseous oxidizing agent through said catalyst beds and into contact with said reaction stream with said catalyst beds;
(d) irradiating said catalyst beds containing said reaction stream with electromagnetic radiation in the ultraviolet or visible light range at an intensity sufficient to activate said photoreductant and produce a free radical to initiate polymerization of said vinyl aromatic monomer to form a vinyl aromatic polymer; and
(e) recovering said vinyl aromatic polymer from said reactors.

22. The method of claim 21 wherein said reactors are spaced laterally from one another to provide for an array of said reactors with parallel flow of said reaction streams and said gaseous oxidizing agent through said catalyst beds and wherein said catalyst beds are irradiated with a source of electromagnetic radiation located internally of said array.
